(19) United States
(12) Patent Application Publication
(10) Pub. No.: US 2016/0038978 A1
(43) Pub. Date: Feb. 11, 2016

(54) SOLDER SPHERE SORTING

(71) Applicant: Heraeus Deutschland GmbH & C. KG, Hanau (DE)

(72) Inventors: Christelle FAVRE, Aix Les Bains (FR); Stephane VARVAT, Chambery (FR)

(21) Appl. No.: 14/779,897

(22) PCT Filed: Mar. 24, 2014
(86) PCT No.: PCT/EP2014/055825

§ 371 Date: Sep. 24, 2015

(30) Foreign Application Priority Data
Mar. 27, 2013 (FR) 1352758

(51) Int. Cl. B07B 13/11; B07B 13/00

(52) U.S. Cl. CPC B07B 13/11; B07B 13/003

(57) ABSTRACT

A method for sorting balls to separate those having a sphericity defect from spherical balls includes depositing the balls to be sorted on a support having a conical surface, applying vibrations to the support to cause the balls having a sphericity defect to follow an upward trajectory on the conical surface while the spherical balls roll downwards on the surface, evacuating the balls having a sphericity defect via a first orifice arranged in the upper part of the support, and evacuating the spherical balls via a second orifice arranged in the lower part of the support. Also provided is a device for implementing the sorting method.

### CROSS-REFERENCE TO RELATED APPLICATIONS

This application is a Section 371 of International Application No. PCT/EP2014/055825, filed Mar. 24, 2014, which was published in the English language on Oct. 2, 2014 under International Publication No. WO 2014/154626 A1, and the disclosure of which is incorporated herein by reference.

### BACKGROUND OF THE INVENTION

The present invention relates to a device and a method for sorting balls to separate, among the balls, those that are spherical from those suffering from a sphericity defect or lack of sphericity.

The electronics industry requires solder micro-balls that are perfectly calibrated for connecting chips onto a carrier circuit so as to form a device known as a “system in package”.

The balls are deposited on the surface of the chip at the output connections, the chip is then turned over (so-called “flip chip” operation) and placed in contact with the carrier circuit.

The melting of the balls when being passed through a re-melt oven then allows the electrical connection of the two surfaces (the connection pads being called “solder bumps”).

To ensure perfect connecting of all of the output pads, all of the solder bumps formed by melting of the balls must have the same height, which is possible if all the balls have the same volume.

The balls must therefore be perfectly calibrated; i.e., their diameters must lie between very tight limits.

Solder balls are typically produced using a so-called “prilling” process whereby the constituent material of the balls is melted and fractionated to form spherical droplets which are then solidified, followed by precise screening.

These two steps allow balls of precise diameter to be obtained.

However, some balls may have sphericity defects which cause variations in the volume of the solder balls and, in fine, variations in the height of the solder bumps.

For example, one fairly frequent sphericity defect is a ball whose volume is twice that of a spherical ball: the double ball has a width equal to the desired diameter but a length that is about twice the width.

This type of defect cannot be eliminated by mere screening (since the width of the ball is equal to the normal diameter, the ball is able to pass through the screen mesh).

Solely a sorting operation is able to remove these non-spherical balls.

Several sorting systems are available with which it is possible to select particles having a particular sphericity.

Most of these systems entail rolling the particles on sloped surfaces optionally subjected to vibrations.

The trajectory of the spherical particles is then different from the trajectory of the non-spherical particles allowing sorting to be obtained.

Typically, the system used for sorting solder balls is formed of a flat plate inclined at a predefined angle allowing the most efficient separation possible.

Under the effect of the vibrations, the balls having a sphericity defect follow a different trajectory on the plate than that followed by the spherical balls, and can therefore be separated therefrom.

Optionally, several plates are arranged in series so as to remove a maximum number of balls having a sphericity defect.

Systems of this type are notably described in U.S. Pat. No. 3,464,550 and Japanese Patent No. 4130936.

It has also been proposed to conduct the sorting on a conical surface.

For example, U.S. Pat. No. 4,059,189 describes a sorting device comprising a surface of flattened cone shape which is driven in rotation about its axis. The balls to be sorted are deposited in a central region of the support surface. Under the effect of centrifugal force, the spherical balls migrate towards the periphery of the support surface and are collected on the periphery of the surface, whilst the balls having a sphericity defect remain on the surface and can then be removed.

U.S. Pat. No. 4,068,758 describes a sorting device comprising a conical surface driven in rotation about its axis. The balls to be sorted are deposited in a central region of the support surface. The spherical balls roll towards the periphery of the surface where they are collected, whilst the balls having a sphericity defect remain on the support surface and are evacuated by means adapted to guide the balls towards another region of the periphery of the surface for evacuation thereof.

However, this sorting method has several disadvantages.

First, the capacity of known sorting devices is much smaller than the capacity of the device for manufacturing the balls and is also smaller than the capacity of the screening device. As a result, so as not to penalize the production rate of the ball manufacturing device, it is necessary to multiply the number of sorting devices which is costly both in terms of investment and labor and which further requires an increase in the production surface area.

Additionally, this operation is relatively long and the vibrations to which the balls are subjected lead to degradation thereof.

Also, the cleaning of the sorting device between two sorting operations is lengthy and tedious, which translates as a low occupancy rate of the device and high labor demand.

Finally, this method is not fully reliable and it is possible that balls having a sphericity defect can still be found after sorting.

It is therefore one objective of the present invention to provide a sorting method and device with which it is possible to eliminate balls having a sphericity defect in a reliable and expedient manner without damaging the sorted balls. Another objective of the present invention is to design a sorting device which is easy to clean.

### BRIEF SUMMARY OF THE INVENTION

In one embodiment, the present invention relates to a ball sorting device and method to separate spherical balls from those having a sphericity defect. The device is preferably low-cost and self-standing.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 illustrates the principle of one embodiment of the present invention;

FIG. 2 is a view of a vibrator comprising two offset eccentric weights;

FIGS. 3A and 3B schematically illustrate a side view and an overhead view, respectively, of the trajectory of the balls in accordance with one embodiment of the present invention;

FIGS. 4A and 4B schematically illustrate a side view and an overhead view, respectively, of the trajectory of the balls in accordance with another embodiment of the present invention;

FIGS. 5A and 5B schematically illustrate a side view and overhead view, respectively, of the trajectory of the balls in accordance with another embodiment of the present invention;

FIGS. 6A and 6B schematically illustrate a side view and an overhead view, respectively, of the trajectory of the balls in accordance with another embodiment of the present invention; and

FIG. 7 illustrates a collection chute for the spherical balls, arranged on the slope of the conical support.

### DETAILED DESCRIPTION OF THE INVENTION

The present invention relates to a ball sorting device and method to separate spherical balls from those having a sphericity defect.

By the term “ball” in the present text is meant a particle of a generally spherical shape.

Among the balls to be sorted, a distinction is made between spherical balls which are considered to be retained and balls having a sphericity defect which are to be eliminated.

The balls to be retained are perfectly spherical or at least sufficiently spherical in relation to specifications for the fabrication method of the balls; i.e., lying within a tolerance range defined by the method. In the remainder of the text, the balls to be retained will be qualified as “spherical balls”.

The balls to be eliminated, on the other hand, have a sphericity defect lying outside the tolerance range which means they are considered to be insufficiently spherical as per the specifications. This sphericity defect particularly includes double balls.

The term “double ball” designates a ball having a volume substantially equal to twice the volume of a spherical ball. The double ball possibly has the shape of two spherical balls joined together or an ovoid shape, with a width that is smaller than the diameter of a spherical ball and a length that is longer than twice this diameter.

The discrimination between balls to be retained and balls to be eliminated is based on the capability of the balls having a sphericity defect to move up along a conical surface under the effect of vibrations. The spherical balls are not able to reach the same height on the surface as the balls having a sphericity defect.

According to the present invention, the method comprises:
depositing the balls to be sorted on a conical surface, the axis of the cone being vertical;
applying vibrations to the surface, so as to cause the non-spherical balls to follow an upward trajectory on the conical surface, whilst the spherical balls roll down toward the bottom on the surface,
evacuating those balls having a sphericity defect via an orifice arranged in the upper part of the support; and
evacuating the spherical balls via an orifice arranged in the lower part of the support.

Advantageously, the balls to be sorted are deposited in an upper half region of the conical surface.

According to an embodiment of the present invention, the conical surface preferably has a line of steeper slope moving upward from the periphery of the support surface towards its center.

In this case, the evacuation orifice for the balls having a sphericity defect is preferably arranged in the center of the support surface, whilst the evacuation orifice for the spherical micro-balls is arranged in a peripheral region of the surface.

In addition, the support preferably comprises a chute for collecting the spherical micro-balls which extends over the conical surface towards the center of the support starting from the evacuation orifice of the micro-balls.

The vibrations are preferably applied so as to cause narrowing of the trajectory of the micro-balls having a sphericity defect, on the conical surface of the conical support.

The vibrations may also be applied so as to impart a circular trajectory to the micro-balls having a sphericity defect for better distribution of the balls to be sorted on the conical surface and improved sorting efficacy.

According to another embodiment of the present invention, the conical surface has a downward slope from the periphery of the support surface towards the center thereof.

In this case, the evacuation orifice for the balls having a sphericity defect is preferably arranged in a peripheral region of the support, whilst the evacuation orifice for the spherical balls is arranged in the center of the support.

The vibrations are advantageously applied so as to cause widening of the trajectory of the non-spherical balls on the conical surface.

According to one preferred embodiment, the vibrations are applied by a vibrator comprising two unbalanced eccentric weights secured to one same vertical shaft and the offset between the two the eccentric weights is adjusted to impart a determined trajectory to the balls having a sphericity defect.

Preferably, the slope of the conical surface has an angle of between 1 and 20° from the horizontal.

According to one advantageous application of the present invention, the balls to be sorted are solder balls.

Preferably, the mean diameter of the balls to be sorted is between 20 and 200 μm.

In one embodiment, the present invention relates to a ball sorting device to implement the above-described method.

The ball sorting device comprises:
a support having a conical surface, the axis of the cone being vertical;
a ball feed device arranged to deposit the balls to be sorted on the conical surface; and
a vibrator secured to the support, the vibrator being adapted to generate vibrations of the support;

wherein the conical surface has:
an orifice to evacuate non-spherical balls, arranged in the upper part of the support; and
an orifice to evacuate spherical balls, arranged in the lower part of the support.

According to one preferred embodiment, the vibrator comprises an upper eccentric weight and a lower eccentric weight secured to a vertical shaft, the lower eccentric weight being offset at an angle from the upper eccentric weight.

According to one embodiment of the present invention, the conical surface preferably has a slope moving upwards from the periphery of the support toward the center thereof.

In this case, the orifice to evacuate balls having a sphericity defect is arranged in the center of the conical surface, whilst the orifice to evacuate spherical balls is arranged in a peripheral region of the conical surface.

In a particularly advantageous manner, the conical support comprises a chute to collect the spherical balls, extending toward the center of the support from the evacuation orifice of the balls.

According to another embodiment of the present invention, the conical surface has a slope moving downwards from the periphery of the support toward the center thereof.

In this case, the evacuation orifice for the non-spherical balls is arranged in a peripheral region of the support, whilst the evacuation orifice for the spherical balls is arranged in the center of the support.

Preferably, the feed device is arranged so as to deposit the balls to be sorted on the upper half of the conical surface.

Finally, the slope of the conical surface advantageously has an angle of between 1 and 20° from the horizontal.

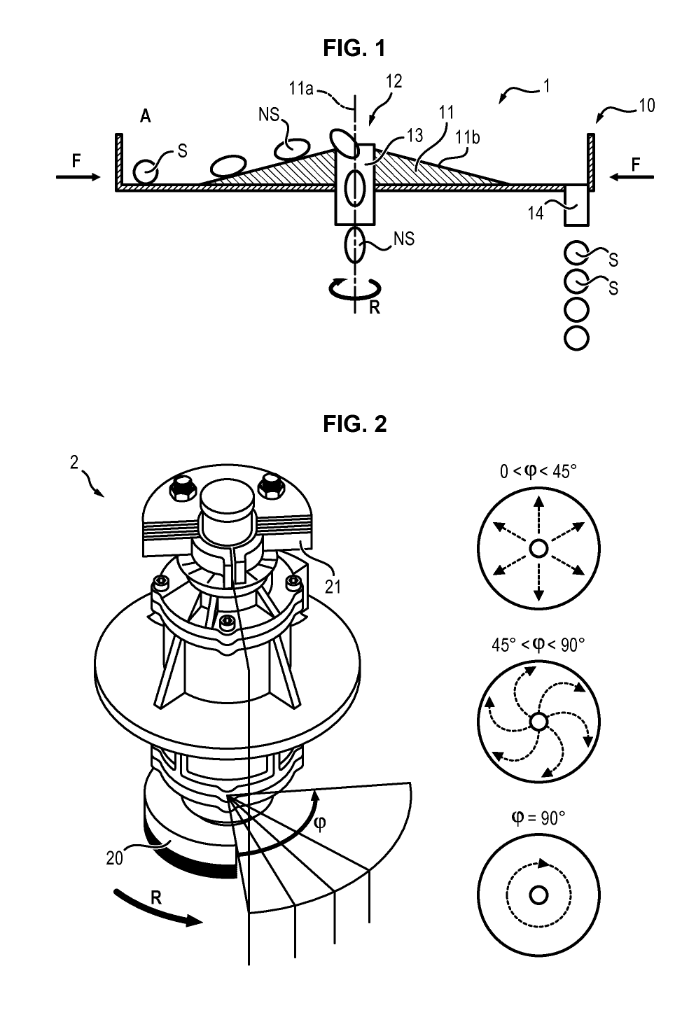

FIG. 1 shows a schematic drawing of the sorting device according to one embodiment of the present invention.

The device comprises a support 1 having a surface 11 of conical shape.

The base of the cone extends over a horizontal plane, the axis 11a of the cone being vertical.

The conical surface 11 is defined by a line having a steeper slope 11b which is the generating line of the cone.

The slope of the surface 11 is defined as being the angle between the line having the steepest slope 11b and a horizontal axis.

This angle is typically between 1 and 20°, and preferably between 1 and 10°, and further preferably of the order of 5°.

Optionally, the support, on its periphery, may comprise a conical surface having a less steep slope than the surface 11.

The support 1 here is shown as a convex shape, the slope of the surface 11 moving upwards from its periphery 10 toward its center 12, but as will be seen below that the support may also be concave with the slope of the surface 11 moving downwards from its periphery toward its center.

The surface of the support has a particularly hard and smooth surface condition to facilitate movement of the balls to be sorted.

Preferably, the mean roughness Ra is less than 0.2.

The surface condition may be obtained by fine polishing of the support (also called “ultra-finishing”) and, optionally, by a surface treatment allowing the hardness of the support to be increased at least on the top surface.

The support can be made of aluminum, for example (which has undergone surface treatment intended to increase the hardness thereof), or stainless steel.

The support 1 also comprises two separate orifices located at different points on the cone to collect firstly the spherical balls and secondly those having a sphericity defect.

One orifice 13 is located in the upper part of the support 1 to collect the balls having a sphericity defect.

In the embodiment illustrated here, the orifice 13 is located in the center of the support which coincides with the apex of the conical surface 11.

An orifice 14 is located in the lower part of the support 1 to collect the spherical balls.

In the embodiment illustrated here, the orifice 14 is located on the periphery of the support, in a region having a gentler slope than the slope of the surface 11.

In a particularly advantageous manner, the orifice 14 opens into a receptacle in which the spherical balls are collected.

The device also comprises a feed device feeding the balls to be sorted (not illustrated here) which is intended to deposit the balls to be sorted in a determined zone of the conical surface 11 of the support.

The feed zone is advantageously arranged above the evacuation orifice 14 for the spherical balls and below the orifice 13 to evacuate the non-spherical balls.

Preferably, the feed zone A is positioned in the upper half of the conical surface 11 so as to enable the balls having a sphericity defect to move up as far as the collecting orifice while limiting the length of their trajectory.

The feed device typically comprises a funnel-shaped receptacle having an outlet nozzle of a defined diameter allowing control over the flow rate of the balls.

The end of the nozzle is located close to the surface of the conical support (typically at a distance of a few millimeters therefrom), so as not to cause bouncing of the balls on the surface, but it is not in contact with the surface.

The conical support 1 is mounted on a vibrator (not shown).

The vibrator is adapted to impose radial vibrations on the support inducing centripetal forces (schematized by the arrow F) on the balls deposited on the conical surface when, as in the embodiment illustrated here, the support is convex (i.e. the surface has a slope moving upwards from the periphery towards the center).

With a concave conical support (i.e., the surface has a slope moving downwards from the periphery toward the center), the radial vibrations induce centrifugal forces.

According to one advantageous embodiment, the vibrator is adapted to impose circular vibrations on the support combining the radial vibrations with a rotational movement (schematized by the arrow R).

One example of the vibrator is described in more detail below.

When in operation, the balls to be sorted deposited on the support follow a different trajectory under the effect of the vibrations depending on whether they are spherical balls S or balls having a sphericity defect NS.

The centripetal forces applied to the balls allow the non-spherical balls to be caused to be move progressively upwards along the surface 11 until they reach the evacuation orifice 13 positioned higher than the feed zone A.

Depending upon the parameters for application of the vibrations, the trajectory of the balls may follow the line having the steepest slope 11b or they may describe a spiral on the surface 11.

This capacity of the non-spherical balls to move up along the slope is due to their lack of sphericity.

On the other hand, the spherical balls do not manage to move up along the surface 11 or, even if they start to move up the surface, they do not manage to reach a height as high as the non-spherical balls.

On account of their sphericity, the spherical balls therefore tend to roll down toward the lower part of the support 1, allowing them to be collected via the orifice 14.

Additionally, whether the support 1 is convex or concave, it has the advantage of being easy to clean.

Vibrator

Different types of vibrators are available with which to generate vibrations, circular vibrations in particular.

Typically, the vibrator comprises an upper eccentric weight and a lower eccentric weight secured to one same shaft of vertical rotation.

Each of the eccentric weights is designed to receive additional weights.

Adjustments of the vibrator are made at the two eccentric weights.

There are effectively two types of adjustments which may have an influence on the trajectory and the speed of the balls deposited on the support:

The first type is the number of additional weights on each eccentric weight.

The second type is the angle offset between the upper and the lower eccentric weight.

The number of additional weights has an influence on the vibrational forces (vertical and radial forces).

When choosing the weights to be added for each eccentric weight, a compromise is sought between radial and vertical vibrations to obtain sufficient travel speed of the balls (to minimize sorting time), whilst minimizing vertical vibrations which reduce the efficacy of sorting.

The vibrator is also coupled to a frequency converter allowing modulation of vibrator power and hence an influence on the travel speed of the balls deposited on the support, but not on the trajectory of the balls.

Of course, the adjustment of the vibrator also takes into account the weight of the sorting support placed thereupon, it being specified that the conical support itself is not driven in rotation with the shaft carrying the eccentric weights, but it is the vibrations caused by rotation of the shaft carrying the eccentric weights which are transmitted to the support.

Also, the angle offset of the upper eccentric weight from the lower eccentric weight has an influence on the trajectory of the balls.

At the factory, the upper eccentric weight is generally positioned on the reference mark 0° which corresponds to the 0° reference mark on the lower eccentric weight.

It is considered here that only the lower eccentric weight is moved to obtain the offset.

FIG. 2 illustrates different types of trajectories according to the chosen offset φ between the lower eccentric weight 20 and the upper eccentric weight 21 of a vibrator 2.

In general, from an overhead view, a ball moves away from the center toward the periphery of the support for an offset of between 0° and 90° and, on the contrary, is directed from the periphery toward the center for an offset of between 90° and 180°.

More specifically, the following types of trajectories can be observed:
for an angle offset of between 0° and 45°, a ball is guided directly from the center toward the periphery following a straight trajectory (“simple widening”);
for an angle offset of between 45° and 90°, the ball is directed from the center toward the periphery following a curved trajectory (“rosette widening”);
for an angle offset of 90°, the ball does not move radially but simply rotates;
for an angle offset of between 90° and 135°, the ball is directed from the periphery toward the center following a curved trajectory (“rosette narrowing”); and/or
for an angle offset of between 135 and 180°, the ball is directed directly from the periphery toward the center following a straight trajectory (“simple narrowing”).

However, other devices can be used to generate vibrations, circular vibrations in particular, without departing from the scope of the present invention.

Among these devices, mention can be made of tumbler vibrators, vibrators having several motors on the periphery of the support to be vibrated, or pneumatic vibrators.

The person skilled in the art is able to choose a suitable vibrator from among devices existing on the market and to define the parameters of the device to generate the desired trajectory.

### Particular Embodiments

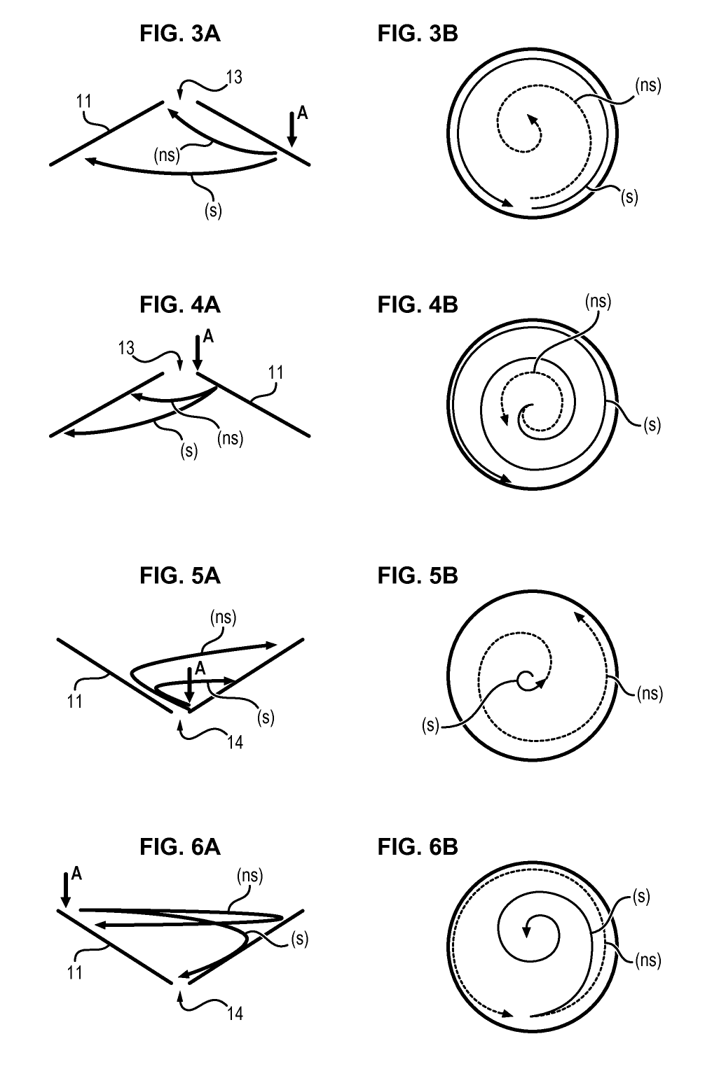

Four embodiments of this device are described with reference to FIGS. 3A to 6B.

In all of these figures, the trajectory of the spherical balls on the support is schematized by curve (s), and that of the balls having a sphericity defect by curve (ns).

FIGS. 3A and 3B, from a side view and overhead view, respectively, schematically illustrate a sorting device in which the support is convex; i.e., the base of the conical surface is located in the lower part of the support and the apex of the conical surface is located in the upper part of the support.

In this embodiment, the feed device deposits the balls to be sorted in a region A which is located in a lower part of the conical surface 11.

In this case, the angle offset of the vibrator is adjusted so as to obtain narrowing of the trajectory of the balls.

For example, an angle offset of 150° is chosen.

The non-spherical balls therefore tend to move up along the surface 11, on account of their lack of sphericity.

With regard to the chosen angle offset, the non-spherical balls move up the slope 11 as far as the collection orifice 13.

On the other hand, the spherical balls do not have this property and roll downward from the feed point toward the bottom of the support where they are collected.

One advantage of this embodiment is that the spherical balls can be easily collected since they are directed toward the periphery of the support.

In addition, this device does not have any region in which the balls accumulate.

Finally, cleaning of this support is quick and easy.

FIGS. 4A and 4B, from a side view and overhead view, respectively, schematically illustrate a sorting device in which, as in the previous embodiment, the conical support 1 is convex.

In this embodiment, the feed device is arranged so as to deposit the balls to be sorted in a region A located in the vicinity of the top part of the support.

For example, the balls are fed into the upper third of the slope, measured as from the apex of the cone.

As previously, the angle offset of the vibrator is chosen so as to obtain narrowing of the trajectory of the balls.

For example, the above-described vibrator can be adjusted with an angle offset of 150° and a frequency of 40 Hz.

In this case, the balls having a sphericity defect remain in the upper part of the support as far as the evacuation orifice. The trajectory of the balls is therefore relatively short.

On the other hand, the spherical balls roll downwards as far as the bottom of the support 1, where they are collected.

As in the previous case, the collection of the spherical balls is easily achieved on the periphery of the conical support.

In addition, the support does not have any region in which the balls accumulate, and can easily be cleaned.

Finally, tests conducted with this device have shown good efficacy in terms of ball separation.

To facilitate collection of the spherical balls on a support having a slope moving upwards from its periphery towards its center, a ball collecting chute is advantageously formed on the surface 11.

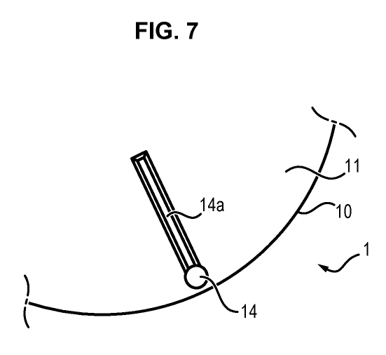

As can be seen in FIG. 7, the chute 14a extends substantially radially from the evacuation orifice 14.

Therefore, the spherical balls which arrive in the lower part of the support encounter this chute 14a, which guides them more rapidly toward the orifice 14.

On this account, the accumulation of balls on the surface 11 is prevented.

FIGS. 5A and 5B, from a side view and overhead view, respectively, schematically illustrate a sorting device in which, unlike in the two preceding embodiments, the support 1 is concave; i.e., the surface 11 has a slope which moves downward from the periphery of the support toward its center.

In the embodiment illustrated here, the feed device is arranged so as to deposit the balls to be sorted in a region A located in the vicinity of the center of the support.

The angle offset of the vibrator is chosen so as to obtain widening of the trajectory of the balls.

For example, an angle offset of 60° is chosen.

In this case, the balls having a sphericity defect move up along the surface 11 toward the periphery of the support, where they are collected.

On the other hand, the spherical balls remain at the bottom of the support and can therefore be collected in the vicinity of the center of the support 1.

One advantage of this device is that the travel time of the spherical balls is short.

Finally, FIGS. 6A and 6B, from a side view and overhead view, respectively, schematically illustrate a sorting device in which, as in the preceding embodiment, the support 1 is concave.

In this embodiment, the feed device is arranged so as to deposit the balls to be sorted in a region A located in the upper part of the support.

The angle offset of the vibrator is chosen so as to obtain widening of the trajectory of the balls.

In this case, the non-spherical balls remain in the upper part of the support and move up the slope as far as the evacuation orifice located on the periphery.

On the other hand, the spherical balls roll downwards to the bottom of the support 11, where they are collected.

During validation tests, this device proved to be very efficient in terms of quality of separation (the final control not having detected any ball with a sphericity defect among the collected spherical balls) and in terms of production rate, with separation being almost instantaneous and the travel time of the balls being very short (e.g., less than about ten seconds).

Of course, the examples just given are only particular illustrations that are in no way limiting regarding the fields of application of the present invention.

For example, while the above-described examples concern solder balls, the sorting method can be applied to other types of balls irrespective of their material and with diameters of typically between 20 and 200 μm.

In this event, the person skilled in the art is able to adapt the material and surface condition of the conical support in relation to the material of the balls to be sorted.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1.-21. (canceled)

22.-42. (canceled)

43. A method for sorting balls to separate non-spherical balls from spherical balls, the method comprising:
depositing the balls to be sorted on a support (1) having a conical surface (11), an axis (11a) of the conical surface being vertical;
applying vibrations to the support (1) so as to cause the non-spherical balls to follow an upward trajectory on the conical surface (11), while the spherical balls roll downwards on the conical surface;
evacuating the non-spherical balls via an orifice (13) arranged in an upper part of the support; and
evacuating the spherical balls via an orifice (14) arranged in a lower part of the support.

44. The method according to claim 43, wherein the balls to be sorted are deposited in a region of an upper half of the conical surface (11).

45. The method according to claim 43, wherein the conical surface (11) has a line of steeper slope (11b) moving upward from the periphery of the support toward its center.

46. The method according to claim 45, wherein the vibrations are applied so as to cause narrowing of the upward trajectory of the non-spherical balls on the conical surface of the support.

47. The method according to claim 46, wherein the vibrations are applied so as to cause a circular trajectory of the non-spherical balls.

48. The method according to claim 45, wherein the vibrations are applied so that the upward trajectory of the non-spherical balls follows the line of the conical surface (11) having the steepest slope.

49. The method according to claim 43, wherein the conical surface has a slope moving downwards from a periphery of the support toward its center.

50. The method according to claim 49, wherein the vibrations are applied so as to cause widening of the trajectory of the non-spherical balls on the conical surface.

51. The method according to claim 43, wherein the vibrations are applied by a vibrator comprising two eccentric weights secured to one common vertical shaft, and wherein an offset between the two eccentric weights is adjusted to impose a determined trajectory upon the non-spherical balls.

52. The method according to claim 43, wherein the balls to be sorted are solder balls.

53. The method according to claim 43, wherein a mean diameter of the balls to be sorted is between 20 and 200 μm.

54. The method according to claim 43, wherein the non-spherical balls are double balls.

55. A device for sorting balls including spherical balls and non-spherical balls, the device comprising:
a support (1) having a conical surface (11), an axis (11a) of the conical surface being vertical;
a ball feed device arranged to deposit the balls to be sorted on the conical surface;
a vibrator secured to the support, the vibrator being adapted to generate vibrations of the support (1);
wherein the conical support has a first orifice (13) to evacuate the non-spherical balls arranged in an upper part of the support and a second orifice (14) to evacuate the spherical balls arranged in a lower part of the support.

56. The device according to claim 55, wherein the vibrator comprises an upper eccentric weight and a lower eccentric weight secured to a vertical shaft, the lower eccentric weight being offset at an angle from the upper eccentric weight.

57. The device according to claim 55, wherein the conical surface (1) has a slope (11) moving upward from a periphery (10) of the support toward its center (12).

58. The device according to claim 57, wherein the first orifice (13) is arranged in the center of the conical support (1) and the second orifice (14) is arranged in a peripheral region of the conical support.

59. The device according to claim 57, wherein the conical support (1) comprises a chute (14a) to collect the spherical balls, the chute extending toward the center of the support from the second orifice (14).

60. The device according to claim 55, wherein the conical surface has a slope moving downward from a periphery of the support toward its center.

61. The device according to claim 60, wherein the first orifice is arranged in a peripheral region of the support and the second orifice is arranged in the center of the support.

62. The device according to claim 55, wherein the ball feed device is arranged so as to deposit the balls to be sorted on an upper half of the conical surface.

63. The device according to claim 55, wherein a slope of the conical surface has an angle of between 1 and 20° from the horizontal.
